(19) United States
(12) Patent Application Publication
(10) Pub. No.: US 2004/0143522 A1
(43) Pub. Date: Jul. 22, 2004

(54) System, computer product and method for web-enabled accounting

(76) Inventors: George Henry Wall, Toronto (CA); Andrew Marshall Wall, Toronto (CA); Jerome Samuel Henshall, Collingwood (CA); David Franklin Bolivar, Toronto (CA)

Correspondence Address: MILLER THOMPSON, LLP, 20 QUEEN STREET WEST, SUITE 2500, TORONTO, ON, M5H 3S1, CA

(21) Appl. No.: 10/345,246

(22) Filed: Jan. 16, 2003

(51) Int. Cl. G06F 17/60

(52) U.S. Cl. 705/34

(57) ABSTRACT

A system, computer product and method for providing a set of documents reconciled in accordance with business rules via the Internet is provided. The system, computer product and method of the present invention enables web-based bookkeeping in particular. A client provides a plurality of business documents to the operator of a web server. The business documents are provided electronically or in the form of scanned images the documents or via data entry interfaces. The web server includes a series of tools that enable the business documents to be converted into reconciled books such that access to supporting documents is readily available in accordance with a series of business rules.

### FIELD OF THE INVENTION

This invention relates in general to a method, system and apparatus for providing accounting over the Internet. More particularly, this invention relates to a system, method and computer product for creating a reconciled set of electronic books based on supporting source documents such as cheques, invoices, receipts, contracts, purchase orders, shipping documents and the like.

### BACKGROUND OF THE INVENTION

The typical accounting cycle for an organization begins with bookkeeping. Bookkeeping relates to the creation of “reconciled” books whereby transactions against a client's various bank accounts are recorded for, explained, and documented. This process involves, for example, the cross-referencing of transactions reflected in a bank statement for a particular bank account with the various underlying financial documents such as cancelled cheques, expense receipts, invoices, and so on. This typical accounting cycle is illustrated in FIG. 1.

The underlying documents take on a variety of forms. The key element is that they record information about financial transactions. Traditionally financial documents are recorded on paper. More recently, many financial documents have become electronic in nature and are the result of Electronic banking transactions (INTERAC, direct deposit, direct withdrawal) or eCommerce. These documents are directly assimilated by the invention described below. Electronic bank statements, eMail invoices, web page receipts are all part of the underlying documents that the invention includes in the bookkeeping reconciliation process. It should be understood that the term “financial documents”, as used in this disclosure, includes all of the above documents. “Financial data” relates to the data contained in such financial documents.

Bookkeeping is generally contrasted from other accounting services such as financial statement preparation, tax filing, tax planning, audit services and so on.

Once the reconciled books have been completed for the target reporting period, the next step is the preparation of Financial Statements. In this step, an accountant starts with the reconciled books and makes adjustments for accruals and amortization. Typically, the results are an Income Statement Report and Balance Sheet Report. After this step, the accountant may then do tax filings and tax planning, as may be required by the client. The typical accounting cycle is illustrated in FIG. 2.

The scope of this invention involves the production of reconciled books. The steps that follow such as the preparation of an Income Statement, Balance Sheet, and filing of taxes are not covered by this invention.

Historically bookkeeping methods involve a process of double entries. For every financial transaction debits and credits are created against various accounts. One of these accounts represents the bank. If the books reconcile, then all the debits and credits will add to zero and the account(s) that represent the bank will agree with the closing bank balance(s) at the end of the financial period as reported by the client's bank(s).

The cross-referencing of financial transactions with underlying documents, and the storage of such documents in a manner that supports the verification of documents that underlay the reconciled books represents a significant investment of time and effort.

Double Entry bookkeeping has traditionally been performed by bookkeepers or accountants using manual processes. While there are numerous software accounting packages that are available, because of the relative complexity of the rules around creation of proper reconciled books, these accounting packages have not generally altered these manual processes fundamentally other than to speed the process up. As with fully manual processes, the use of typical accounting software still requires the skill of a qualified bookkeeper.

There is a need for a system, computer product, and method for web based bookkeeping, whereby functions related to the creation of reconciled books are reduced to data entry functions with built in control mechanisms. This reduces the need for bookkeeping knowledge in the production of reconciled books.

There is a further need for a system, computer product and method of web based bookkeeping whereby reconciled books, financial statements and other accounting documents are generated that permit underlying financial documents relating to particular entries in such accounting documents to be verified in a quick and simple manner by persons that are not necessarily accountants or bookkeepers such as managers, directors, shareholders, or other stakeholders. This mechanism provides what is referred to as “Financial Transparency”.

### SUMMARY OF THE INVENTION

It is an object of the present invention to provide a system, computer product and method for a system, computer product, and method for web based bookkeeping, whereby functions related to the creation of reconciled books are reduced to data entry functions with built in control mechanisms.

Another aspect of the present invention is a system, computer product and method of web based bookkeeping whereby reconciled books, financial statements and other accounting documents are generated that permit financial documents relating to particular entries in such accounting documents to be verified from the accounting documents by persons that are not accountants.

A further aspect of this invention is to provide financial information to end clients in an on-line manner such that multiple persons in different locations can view the same information simultaneously. This provides transparency to multiple parties who may need to know the financial goings on of an organization.

### BRIEF DESCRIPTION OF THE DRAWINGS

A detailed description of the preferred embodiment(s) is(are) provided herein below by way of example only and with reference to the following drawings, in which:

FIG. 1 is a flowchart illustrating the prior art process for reconciling books.

FIG. 2 is a flowchart illustrating the typical prior art accounting cycle, and the subject matter of the present invention as it relates to this accounting cycle.

FIG. 3 is a system component chart in accordance with one embodiment of the present invention.

FIG. 4 illustrates the resources of the software product of the present invention, in accordance with one embodiment thereof.

FIG. 5 is a flowchart illustrating workflow in accordance with the method of the present invention.

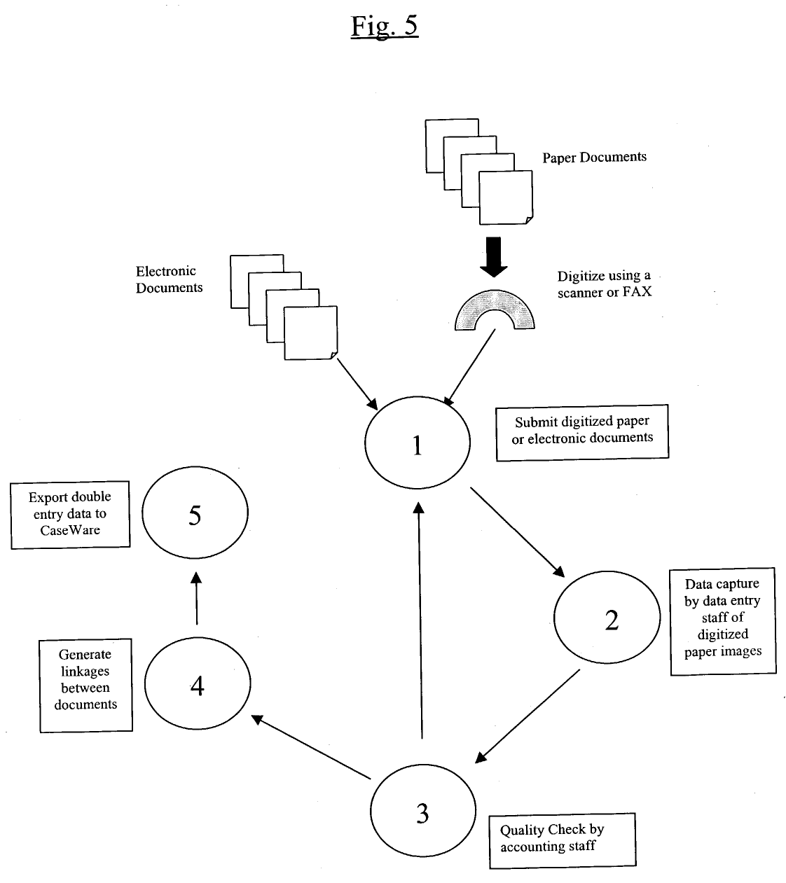

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

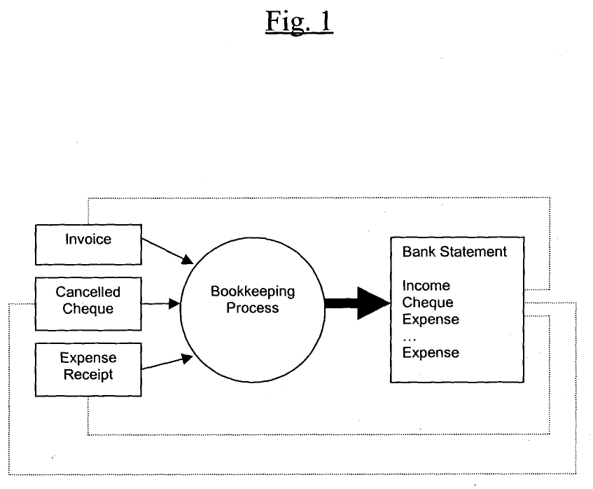

Referring to FIG. 1, the general process involved in creating reconciled books is illustrated, as explained above.

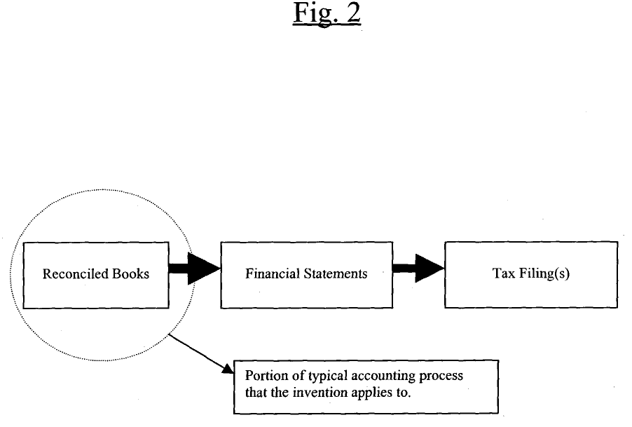

Referring to FIG. 2, the invention relates generally to the creation of reconciled books based on financial documents.

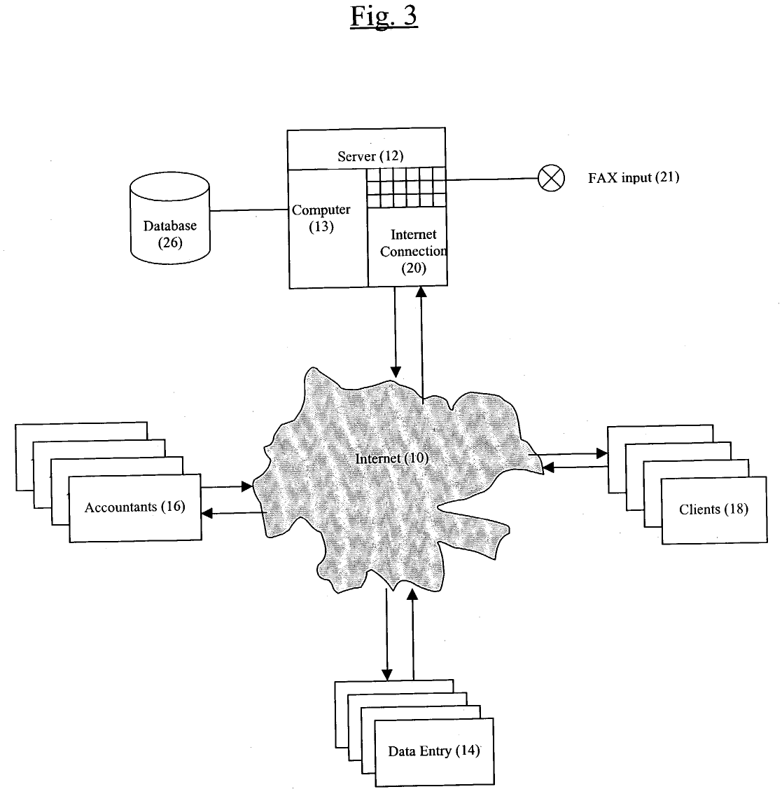

Now referring to FIG. 3, there is illustrated a system component flow chart for the system of the present invention. By means of the Internet medium 10, Server 12 is made accessible to one or more Users.

In accordance with the method of the present invention, there are generally three categories of Users. The first category is “Data Entry Personnel” 14 generally comprising data entry clerks.

The second category is “Accounting Personnel” 16. As explained below, the function of the “Accounting Personnel” is to exercise quality control in regard to the data entry functions fulfilled by the Data Entry Personnel 14 to ensure that the reconciled books created in accordance with the present invention meet generally accepted accounting standards, as well as standards of accuracy. The Accounting Personnel is contrasted from the Data Entry Personnel 14 and generally comprises an accountant, bookkeeper, or trained quality control resource. The Accounting Personnel may include accountants associated with the operator of the present invention. Alternatively, the Accounting Personnel may include accountants associated with a licensee accounting firm of the present invention whereby the accountants supervise the creation of reconciled books in accordance with the present invention.

A third category is “Clients” 18. “Clients” are the originators of the accounting data for whom the reconciled books are being created. Examples of such category include a private business, public corporations, government organizations, non-profit organizations, and so on.

It should be further understood that the description of the present invention draws principally on the example of bookkeeping, and also functions in support of accounting. It should also be understood, however, that the present invention applies to other contexts as well where generation of reports depends on the reconciling of a plurality of supporting documents in accordance with a set of business rules, and whereby verification of the reports requires ready access to the underlying supporting documents.

One aspect of the present invention is the provision of a private web site for each individual client. Security measures are implemented (in this case a user ID and password) to ensure that one client cannot see another client's information. For reasons of economy the websites of all clients are generally hosted by a single web server 12. Each private website provides an area that indexes and stores the raw input documents as well as published financial reports for that particular client. The private web sites also provide tools for clients to submit images of financial documents and electronic commerce data files as well as facilities to change their password and modify contact information.

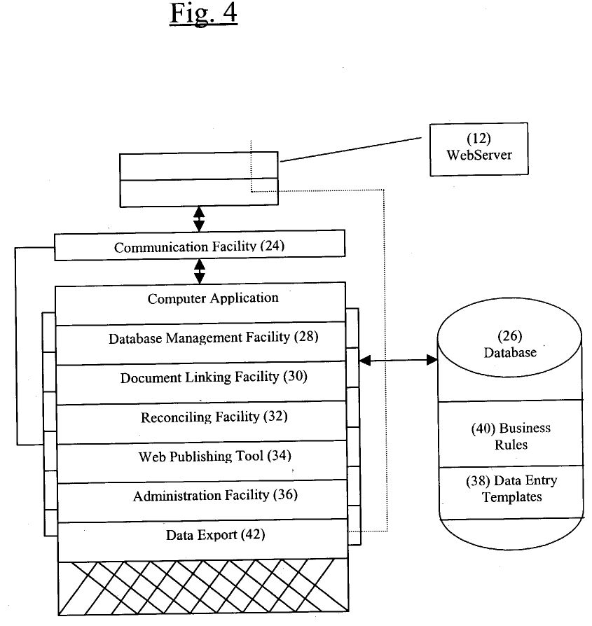

In the embodiments of the present invention illustrated herein, Server 12 comprises a computer 13, an Internet connection 20, communication facility 24 (shown in FIG. 4), database 26, and FAX receiving facility 21. A computer product is loaded on the server 12 that includes a number of facilities including a database management facility 28, a linking facility 30, a reconciling facility 32, a web publication tool 34 and an administration facility 36, as best illustrated in FIG. 4.

Database 26 is a known relational database that supports queries made via the database management facility 28 across a particular segregation of tagged data, in a manner that is known. In a particular embodiment of the present invention, one aspect of the database management facility 28 of the present invention is a known database engine to store document data such as ORACLE™.

In another particular aspect of the database management facility 28, and a particular aspect of the web publication facility 34, a known electronic document storage and retrieval system is used to populate the database 26 with further tagged data provided through a series of web interfaces as described below, and also to retrieve data from the database 26 in a series of web interfaces including web reports. In a particular implementation of the present invention this specific aspect of the present invention is provided using a Netscape™ web server.

The functionality of each of these elements of Server 12 is discussed below. It should be understood, however, that the present invention encompasses providing the Internet environment described herein through the auspices of a variety of types of Internet connections, whether LAN connections, fiber optic cable connections, wireless Internet connections, and so on. It should also be understood that the present invention encompasses providing the Server 12 through any number of equivalents including any combination of hardware and software which enables the functions of this invention to be provided via the Internet, or any other inter-connected network of computers. Also, database 26 and database management facility 28 can be provided by a wide array of custom or off-the-shelf database and database management products. In addition, said database management facility 28 can also incorporate a number of tools for identifying and manipulating relevant data, such as known knowledge management tools.

The present invention also contemplates the interoperability of database 26 and database management facility 28 with other networks such as a corporate LAN, for example, to access from such LAN the data contained in database 26 or to make changes to the settings of database management facility 28 on a remote basis.

Administration facility 36 is a known tool that is controlled by the operator of Server 12 for controlling access to the resources of the Server 12, which are particularized below. The administration facility 36 is an important aspect of the present invention in that it ensures segregation of functions as between Data Entry Personnel 14, Accounting Personnel 16 and Clients 18. This segregation of functions ensures the integrity of the reconciled books created in accordance with the present invention. The Administration facility 36, for example, is the technical means for ensuring that Data Entry Personnel 14 can only access the specific data entry interfaces referenced below; that only Accounting Personnel 16 can access the reconciling interfaces referenced below; and Client 18 can only access particular areas of the web site 20 that show the results of the present invention, i.e. their reconciled books, without revealing the underlying linking and reconciliation process described herein.

The Administration facility 36 and web publication tool 34 cooperate to provide an “ADMINISTRATOR'S HOME PAGE” which includes the various functions associated with the operation of the present invention. This home page provides a number of functions.

A first representative function is the ability to monitor the “SYSTEM STATUS”. This function allows the Administrator to verify the users that are currently logged in, and also to access a “TIME STAMPED LOG”. This function has a number of benefits. It allows management of resources, but also tracking of activities of Data Entry Personnel 14, Accountants 16, and clients 18.

A second representative function is the “USER ADMINISTRATION” function which permits such sub-functions as “FIND CLIENT USER”, “FIND STAFF USER”, “CHANGE PASSWORD”, “CREATE NEW CLIENT USER”, “CREATE NEW STAFF USER”, and “ADD NEW USER GROUP”. By using these functions, the administrator can change information about the users and assign access rights and privileges.

In a third representative function, there is an “IMAGE HANDLING FUNCTION” whereby the process of capturing of electronic images described below is managed by such sub-functions as “INSTALL IMAGES”, “SHOW ALL REWORKS”, “SHOW ALL REWORKS FOR USER” and so on.

In a fourth representative function, a “SYSTEM MAINTENANCE” function includes a number of sub-functions that allow administration of the various components of the present system described herein, in a manner that is known.

In one embodiment of the Administration Facility 36, the various Users are assigned username/password combinations corresponding to the access levels assigned by the administrator of the Server 12. Accordingly, the various Users can log on to the Server 12 and access the particular resources of the Internet Server 12 to which they are given access using a known Internet browser.

The web publication tool 34 permits, in a manner that is known, the creation, publication and population with data of the variety of web pages 36 discussed herein, including indexed source documents and financial reports. Where it is appropriate the financial reports are linked to the underlying documents

It should be understood that the description of the steps of the present invention in consecutive order is not meant to convey that the order of such steps is an essential element of the present invention.

An Administrator of the present invention establishes the various business rules associated with creating a reconciled and linked document based on underlying supporting documents in accordance with the present invention. There are three aspects to these business rules. The first aspect is the business rules for reconciling a plurality of supporting documents to create a higher level document, such as a reconciled set of books based on underlying financial or other documents. The second aspect of the business rules are the rules for linking the underlying supporting documents such that when the higher level document is accessed the supporting documents can also be accessed through a known Internet browser, for example, during verification of the higher level document. The third aspect of the business rules is the specification of how the single entry data that has been captured is converted to the double entries that are the accounting industry norm.

The above described business rules are established in accordance with known principles and stored in a known business rules repository 40 which is part of database 26. The business rules included in the business rule repository 40 are essentially parsing and data conversion rules. The business rules repository in association with the database management facility 28 and database 26 provide the aspects of the present invention described as the linking facility 30 and reconciling facility 32.

The Client 18 then submits financial documents. For paper documents the user must provide a digital image of each page. These images are typically scanned on a client's computer and uploaded to the client's private page. Client's may also submit their paper documents to a scanning bureau for digitization. Alternatively, clients may use the FAX interface 21 to load images of their documents directly to the server 12. Each digitized paper document received by the invention is assigned a unique system wide serial number.

The present invention includes a known fax database utility, whereby a particular Client 18 wishing to submit a particular supporting document logs into the Server 12 and retrieves and prints a fax cover sheet that includes a unique bar code. The cover sheet is faxed along with the supporting document to a particular fax number associated with a fax machine connected to Server 12. The Server 12 is provided with a FAX computer application 21 whereby the bar code is read from the electronic transmission which identifies the Client 18 to the Server. The digitized images of the supporting document are stored in the database 26. The supporting document is now available via the Internet.

For electronic documents (such as an electronic bank statement) the client uploads such document directly using functions on their private web page. Electronic documents are assimilated directly by the invention and stored in the database without the intervention of the data entry staff 14. Each electronic document submitted by each client is assigned a unique system wide serial number.

In a second step of the present invention each newly submitted image is subjected to data capture by the data entry personal 14. In regard to the bookkeeping implementation of the present invention, the data captured includes information that mirrors the contents of documents such as bank statements, bank deposits, bank withdrawals, expenses, and cancelled cheques. This data constitutes an electronic representation of each source document. The data collected is linked to the digitized image of the original paper document.

Data Entry Personnel 14 log into the web site 20 and begin working. One aspect of the present invention is a web page tailored to a particular member of the Data Entry Personnel 14 that helps the member manage their workflow. For example, when the particular member logs in to the web site 20, the web page displayed allows the particular member to begin with data entry where they left off; review log of work completed in the past; and so on. It is also contemplated by the present invention that the administration facility 36 will incorporate tools for managing labor standards whereby Data Entry Personnel 14 performance is measured against engineered labor standards, and the web pages for particular members of the Data Entry Personnel 14 is used to report to the members on their performance compared to these labor standards.

The web pages accessed by the Data Entry Personnel 14 permit a number of functions. First, they permit a search for a particular client. Second, they provide a series of data entry screens, as mentioned above. Third, they permit the Data Entry Personnel to engage both the linking facility 30 and the reconciling facility 32 as stated below.

The web pages provide the Data Entry Personnel 14 with a known search engine for searching for data associated with a particular Client 18 based on key words, alphabetical drop down lists of Clients 18 and so on. Once a particular Client 18 has been located, a link is displayed which provides access via a browser to any data that exists on the database 26 for that particular client. In relation to a Client 18 who has been entered on the database 26 but the process of creating reconciled books in accordance with the present invention has not yet begun, the web publication tool 34 will display in a web page a list of links corresponding with data objects (electronic data or images of paper based documents).

In accordance with a particular embodiment of the present invention, if the Data Entry Personnel 14 clicks on a link associated with a particular data object, a data entry interface is displayed by the web publication tool 34. In one aspect of the present invention, the Data Entry Personnel views the data object and determines based on a drop down menu the type of document that is represented by the data (bank statement, deposit, etc.). In another aspect of the present invention, the database management facility 28 and business rule repository 40 cooperate to analyze the data objects and based on business rules determine the type of document that is likely represented by the data object.

Generally speaking, the data entry process begins with a document that tends to summarize the various transactions that will have to be reconciled. For example, in relation to the creation of reconciled accounting books for a business, the data entry process begins with the various bank statements of that business. In accordance with one aspect of the present invention therefore, if the bank statements are not available electronically, the Data Entry Personnel 14 will click on each bank statement in the list of data objects. This will bring up a web page that consists of a particular data entry interface for bank statements. It is an aspect of the present invention, that once the type of document is identified for a data object, a web template 38 corresponding to that type of document is accessed and displayed for managing the workflow of the Data Entry Personnel 14.

The business rule repository 40 contains the various rules determining the workflow process for keying the data for a particular financial document, in association with the web templates 38. Generally speaking each web template 38 consists of a display area that displays the actual data object. This display area generally permits the Data Entry Personnel 14 to scroll up or down on the data object, vary the size of the data objects vis-a-vis the balance of the data entry interface, vary the size of the characters in the data object, and zoom in on parts of the data object that are particularly difficult to read. The web templates 38 also generally include a series of drop down menus that permit certain values to be selected, for example, the type of transaction represented by a data object, or a particular transaction listed in a data object such as a bank statement. Lastly, the web templates 38 also include one or more data entry fields wherein information is entered manually by the Data Entry Personnel 14.

For example, in relation to a bank statement, the Data Entry Personnel 14 will generally pick the nature of the transaction, “BANK STATEMENT”, from a scroll down menu. The Data Entry Personnel 14 will then proceed line by line and ensure that each line of the data in the bank statement is entered. Scroll down menus are provided to pick the nature of the particular entry in the bank statement, for example, “CASH WITHDRAWAL”, “CHEQUE”, “DEBIT CARD WITHDRAWAL”, “DEPOSIT”, “SERVICE CHARGE”, “TRANSFER IN”, “TRANSFER OUT”, “UNKNOWN CREDIT” and “UNKNOWN DEBIT”. In relation to the particular entries, the data entry interface requires the entry of specific information. For example, in relation to a cheque, the “DATE”, “AMOUNT”, and “CHEQUE NUMBER” is required.

The various underlying documents are also entered. For example, data entry interface specific to cancelled cheques shown in the bank statements, expenses corresponding to payments reflected in the bank statements are also accessed and the pertinent data is entered in a similar fashion.

The result of the above process is that the data contained in the data objects displayed in the list of documents of a particular Client 18 is fully entered in the database 26. In one aspect of the present invention, when the requisite data for a particular data object, in accordance with the business rules contained in the business rules repository 40, has been entered, the particular data object will be “CHECKED” or indicated in some other way in the list of documents of a particular Client 18. This also assists in managing workflow.

The third step is performed after the data entry personal have captured data for all the digitized images submitted by the client 18, or after the client 18 has submitted electronic documents (such as a bank statement). The third step is a quality check by the accounting staff 16. To perform this step a special data analysis tool, which is built into the invention, is used. The analysis tool attempts to reconcile the financial data for the given time period.

The Reconciler analyzes the relationships between the documents by attempting to find all the underlying documents required to justify each and every bank statement transaction. The Integrity Checker reports the following conditions:

1) Arithmetic errors in the data captured (such as a bank statement not adding up to the closing balance)

2) Transactions on the bank statement that do not have supporting documents (such as a debit card withdrawal that has no receipt)

3) Stranded documents that do not support a bank statement transaction (such as a cheque that has not cleared)

The operation of this reconciling facility 32 is best understood in relation to an example in operation. The example provided illustrates, among other things, how the accounting rules for a particular jurisdiction (in this case Canada) are reflected in the business rules that provide the reconciling facility's 32 logic.

Bank Statements

As stated earlier, the central document is generally a document such as a bank statement. For every line on the bank statement there is a record in the database that records:

1) Transaction Date

2) Transaction Amount

3) Transaction Type (cheque, deposit, debit card withdrawal, service charge, etc)

4) Cheque Number (if applicable)

5) Description (if applicable)

For a given date range (i.e. a business cycle such as a tax year) the reconciling facility 32 examines each bank transaction recorded in the database 26 and locates other documents stored to the database 26 for the same Client 18 as per the following table:

| Transaction Type | Source Documents |
|---|---|
| Deposit | Deposit slip or an Invoice that has been |
| | recorded as deposited |
| Cheque | Cancelled cheque and an expense receipt |
| Service Charge | None |
| Debit Card Withdrawal | Expense receipt |
| Cash Withdrawal | None |
| Transfer Out | Corresponding transfer in from another bank |
| | account |
| Transfer In | Corresponding transfer out to this bank account |

Documents are located using the following rules:

| Document | |
|---|---|
| Type | Rules for Locating |
| Deposit Slip | A deposit for the target amount (in the same currency as |
| | the bank account) into the target bank account dated on |
| | the bank statement date or up to 3 days before. Failing |
| | this mixed or foreign currency deposit slips are |
| | examined to find one that has an amount that is in |
| | between the notional exchange rate HIGH and LOW |
| | values into the target bank account on the bank |
| | statement date or up to 3 days before. |
| Invoice | An invoice for the target amount (in the same currency |
| | as the bank account) dated on the bank statement date |
| | or up to 3 days before. Failing this, foreign currency |
| | invoices are examined to find one that is dated on the |
| | bank statement date or up to 3 days before for an |
| | amount that is in between the notional exchange rate |
| | HIGH and LOW. |
| Cheque | The cheque number, bank account, and amount must |
| | match. Failing this, foreign currency cheques are |
| | examined to find one that is drawn on the target bank |
| | account for an amount that is in between the notional |
| | exchange rate HIGH and LOW. |
| Expense | An expense receipt for the target amount and cheque |
| Receipt paid by | number. Failing this, foreign currency expense receipts |
| cheque | are examined to find one that has the same cheque |
| | number and with an amount that is in between the |
| | notional exchange rate HIGH and LOW. |
| Debit Card | An expense receipt for the target amount that is paid |
| Withdrawal | using a debit card that belongs to the target bank |
| | account. Failing this, foreign currency expense receipts |
| | are examined to find one that was paid using a debit |
| | card that is associated with the target bank account and |
| | with an amount that is in between the notional exchange |
| | rate HIGH and LOW. |
| Transfer Out | A transfer in transaction on the target bank account that |
| | is dated on the transfer out transaction date or up to 7 |
| | days after for the same amount. If the target bank |
| | account is in a foreign currency then the amount must |
| | match within the notional exchange rate HIGH and |
| | LOW. |
| Transfer In | A transfer out transaction on the target bank account |
| | that is dated on the transfer in transaction date or up to |
| | 7 days before for the same amount. If the target bank |
| | account is in a foreign currency then the amount must |
| | match within the notional exchange rate HIGH and |
| | LOW. |

When searching foreign currency documents, the reconciling facility 32 relies on a notional exchange rate table that specifies a factor that converts the foreign currency to Canadian funds (in this example). These rates are generally the monthly average exchange rates published by the Bank of Canada. In addition there is a HIGH and LOW exchange rate value that creates a band around the published rate. This accounts for the fact the actual settling rate for any given foreign exchange transaction is not bound by the Bank of Canada after the fact published rates. If the target values fall within the band it is deemed to be a match.

In order to locate all supporting documents, the reconciling facility 32 also verifies:

1) That when the transactions recorded for a given bank statement are applied to the opening balance the closing balance is obtained. Failure of this to occur indicates a data keying error or the omission of transaction (s).

2) That the opening balance on one bank statement matches the closing balance on the previous statement.

3) That the bank statements for all the bank accounts cover the entire reporting period—that is there are no gaps.

Deposit Slips

After examining the bank transactions, in accordance with this particular example provided for illustration purposes, the reconciling facility 28, then examines the deposit slips, if any. Each deposit slip has one or more entries as specified in the following table:

| Deposit Entry Type | Data Collected |
|---|---|
| Invoice Payment | Amount, Invoice Number |
| Credit Account | Amount, Account Number, and |
| | optional GST and PST amounts |

For the Invoice Payment entries, the reconciling facility 32 verifies that an invoice with the given invoice number exists, and that the amount recorded on the deposit slip matches the total amount of the invoice.

For Credit Account entries, the reconciling facility 32 verifies that the Account Number is valid and that the GST and PST (in this particular example—provincial and federal taxes applicable in Canada) do not add up to more than the amount. Certain account numbers such as the ones set up for the various bank accounts, foreign exchange gain and loss, and transfer clearing are not permitted.

Expense Receipts

The reconciling facility 32 scans all expense receipts for the target date range that have not been linked to the bank statement to determine how they were paid. All receipts that are not paid by a director generate an error with a hyperlink to the expense receipt. If, for example, an expense receipt is recorded as having been paid by a corporate debit card and there is not a corresponding entry in the bank transactions, then an error is issued.

Cancelled Cheques

The reconciling facility 32 reports all cancelled cheques that are not linked to the bank statements.

Invoices

The reconciling facility 32 reports all Invoices that are not paid (i.e. not linked to a bank transaction or deposit slip)

In accordance with the representative business rules identified above, the reconciling facility 32 generates in relation to a particular Client 18 an “ISSUES LIST” that includes information regarding missing documents, uncleared cheques, receivables, errors and the like. Depending on the rules determined by the business rule repository, remediation of some issues may fall on the Data Entry Personnel 18. For example, data entry errors identified in accordance with the above are generally reported immediately to the Data Entry Personnel 14 for rectification. Once the data entry errors have been addressed, the remaining “ISSUES LIST” is generally reported to Accounting Personnel 16 for problem resolution as a reconciling interface. For example, if there are missing documents, the accountant will contact the Client 18 and ask that they submit the missing documents. A list of the missing documents can be sent by email by the accountant in conjunction with communication facility 24. Also, the Accounting Personnel 16 generally can exercise on “OVERRIDE” function provided that an explanation is given, which is as a “READ ONLY” file in database 26.

The “ISSUES LIST” is generally a series of entries containing the following information. First, a reference to a particular business rule (e.g. 408-Missing Cancelled Cheque) from the business rule repository 40 detailing the reason for identification of the issues. Data Entry Personnel 14 or Accounting Personnel 16 can access, for example, from an on-line manual the detailed explanation of the business rule, and proper procedure for remediation. Second, the particular “ISSUE” entry references the other data pertinent to the entry. For example, in relation to a Cancelled Cheque—“MISSING CANCELLED CHEQUE FOR $218 DATE 02-FEB-1999 DRAWN FROM ACCOUNT CIBC (414100 9911411 (CANADIAN)”. The “ISSUES LIST” also generally contains at the end a “PROCESSING SUMMARY” which identifies the categories of the various issues, for example, “NUMBER OF BANK STATEMENTS: 13; NUMBER OF BANK TRANSACTIONS: 189; NUMBER OF INVOICES: 32; NUMBER OF EXPENSES: 202; NUMBER OF DEPOSIT SLIPS: 27.

It should be understood that the reconciling facility 32 is generally engaged after each round of data entry. Further rounds of data entry will generally occur until all the documents are processed for the given reporting period (i.e. usually the tax year) for a particular Client 18.

In a fourth step of the present invention, the linking facility 30 of the present invention is engaged. The linking of various data objects within the database 26 in a known capability. In a particular implementation of the present invention, the linking facility 30 processes data in conjunction with the reconciling facility 32 such that once a batch of data has been reconciled as described above, the associated documents are linked by the linking facility 30. The linking occurs by analyzing the captured data from the source documents and creating links between them. Each and every source document has a unique serial number. Documents are linked by adding the serial number of one document to the data recorded about another document in a manner that is known. For example, if a data object corresponding to a cheque is entered into the system, and a cheque for the same amount, on the same date appears in a bank statement, the cheque and that item in the bank statement will be linked. This process is generally applied across the various data objects included in the database 26.

The result of the above, is the generation of a linked log of all of the documents of a particular Client 18 whereby a User can drive down to documentation supporting any particular entry in the log. In addition, in association with the web publication tool 34 a number of reports can be accessed organizing data retrieved from the database 26 regarding a particular Client 18.

For example, “INVOICES BY CUSTOMER NAME FOR TAX YEAR X” can be accessed. Selection can be made as to whether invoices are to be viewed by “INVOICE NUMBER”, by “DATE DESCENDING”, by “DATE ASCENDING”, etc.

Similar reports and related selections are available for cancelled cheques, bank deposits, bank statements, and so on. Obviously, the selections will vary according to the type of report. For example, in relation to a bank deposit report, data can be viewed “BY ACCOUNT AND DATE”.

As a fifth step of the present invention, it is generally desirable to export the data created in accordance with the present invention. The present invention also includes a data export facility 42 that permits the reconciled and linked data to be exported to an accounting software package.

In one aspect of the present invention, the date export facility 42 converts the reconciled and linked data into a format that is understood by an accounting packages such as for example the known CASEWARE™ accounting software package.

One of the aspects of the present invention, is that the data exported supports the processes of accounting software packages such as CASEWARE™ whereby the accounting data is converted from single accounting entry method data to double accounting entry method data.

Another aspect of the present invention is that the business rule repository 40 includes rules for ensuring that the reconciled and linked data provided in accordance with the present invention is consistent with the data conversion rules of accounting software packages such as CASEWARE™. This is handled by a mechanism referred to as a posting matrix or export facility data export facility 42.

The data export facility 42 is comprised of a list of condition key and action verb pairs. The computer product of the present invention applies such condition key and action verb pair for the purpose of exporting data from the database 26 to third party accounting packages for generating accounting books in accordance with the double entry accounting method. One of the challenges in exporting data to such accounting packages is ensuring that the data exported which includes debits and credits balances out when processed by the accounting software package.

One aspect of the exporting method of the present invention is that each transaction in the database 26 is analyzed to ensure that supporting data required for this transaction to balance in terms of debits and credits are present. Only then is the data required to record the transaction exported to the accounting package.

ConditionKeys

“ConditionKeys” are best understood as a plurality of queries that are applied to the data in the database 26. In a particular embodiment of the present invention these “ConditionKeys” are runtime queries for identifying data in the database 26 of interest for the purpose of exporting data to an accounting software package. Based on the data provided to the database 26 it should understood that numerous permutations are possible such that the potential number of runtime queries that could be applied to the database 26 is extremely high.

One aspect of the present invention is identifying particular ConditionKeys that are of interest from the perspective of exporting data to the accounting software package. In one particular implementation of the present invention, approximately 2,500 ConditionKeys are identified in a manner that is known. These keys are then provided in a manner that they can be applied to the database 26 and also correlated with the ActionVerbs described above.

In a particular implementation of the present invention, this is achieved by creating a database table that is functionally linked with the database 26. The database table includes two rows. The first row includes the various ConditionKeys and the second row includes the various corresponding ActionVerbs (described below).

In the following example the ConditionKey is formatted as a 27 character string with specific values for each character positions. All character positions must be filled. The positions are assigned single character values as follows:

| | | Applies to |
|---|---|---|
| Position | Values | Prefix |
| 1 | As per condition key prefix table | * All * |
| 2 | As per condition key prefix table | * All * |
| 3 | X: trade supplier speced, O: not | BA, D? |
| 4 | X: capital, O: not | BA, D? |
| 5 | X: cheque num speced, O: not | BA, D? |
| 6 | X: share holder speced, O: not | BA, D? |
| 7 | X: personal credit card speced, | D? |
| | O: not | |
| 8 | X: corp credit card speced, O: not | D? |
| 9 | X: personal debit card speced, | D? |
| | O: not | |
| 10 | X: corp debit card speced, O: not | D? |
| 11 | X: direct debit speced, O: not | D? |
| 12 | X: cash withdrawl, O: not | BA |
| 13 | X: debit card trans, O: not | BA |
| 14 | X: direct debit trans, O: not | BA |
| 15 | X: cheque trans, O: not | BA |
| 16 | X: service charge trans, O: not | BA |
| 17 | X: deposit trans, O: not | BA |
| 18 | X: xfer in trans, O: not | BA |
| 19 | X: xfer out trans, O: not | BA |
| 20 | X: unknown credit trans, O: not | BA |
| 21 | X: unknown debit trans, O: not | BA |
| 22 | X: CDN xfer acct speced, O: not | BA |
| 23 | X: US xfer acct speced, O: not | BA |
| 24 | X: deposit slip speced, O: not | BA |
| 25 | X: invoice speced, O: not | BA |
| 26 | X: expense receipt speced, O: not | BA |
| 27 | X: client customer speced, O: not | BA |

So as an example, based on the above, a Canadian cheque clearing a Canadian bank account would generate the following ConditionKey string:

BAOOXOOOOOOOOOOOOOOOOOOOOXO

Some ConditionKey prefix values are as listed in the following table:

| Transaction Category | Prefix |
|---|---|
| Disbursements: | |
| CDN disbursement, paid CDN, GST quick method | DA |
| CDN disbursement, paid CDN, GST long method | DB |
| US disbursement, paid US, GST quick method | DC |
| US disbursement, paid US, GST long method | DD |
| CDN disbursement, paid US, GST quick method | DE |
| CDN disbursement, paid US, GST long method | DF |
| US disbursement, paid CDN, GST quick method | DG |
| US disbursement, paid CDN, GST long method | DH |
| Bank Statement | BA |
| Income: | |
| Invoice | IA |
| Deposit Slip | IB |

The next step is to

ActionVerb

In this example the action verb is a 132 character string that is broken into 22 six character tokens. Each of the 22 tokens specifies what is to be posted to a specific account according to their position in the ActionVerb string as follows:

| | Character | |
|---|---|---|
| Token | Position | Meaning |
| 1 | 1 thru 6 | Due to shareholder (1 . . . N) |
| 2 | 7 thru 12 | A/P US trade supplier (1 . . . N) |
| 3 | 13 thru 18 | A/P CDN trade supplier (1 . . . N) |
| 4 | 19 thru 24 | Outstanding CDN cheques payable |
| 5 | 25 thru 30 | Outstanding US cheques payable |
| 6 | 31 thru 36 | Account associated with document class |
| 7 | 37 thru 42 | Bank US account (1 . . . N) |
| 8 | 43 thru 48 | Bank CDN account (1 . . . N) |
| 9 | 49 thru 54 | GST Payable |
| 10 | 55 thru 60 | Foreign exchange adjustment |
| 11 | 61 thru 66 | Foreign exchange settlement |
| 12 | 67 thru 72 | Suspense - unknown debit |
| 13 | 73 thru 78 | Suspense - unknown credit |
| 14 | 79 thru 84 | A/R CDN client customer (1 . . . N) |
| 15 | 85 thru 90 | A/R US client customer (1 . . . N) |
| 16 | 91 thru 96 | Bank charges account (1 . . . N) |
| 17 | 97 thru 102 | Transfer clearing |
| 18 | 103 thru 108 | PST payable |
| 19 | 109 thru 114 | Bad debts |
| 20 | 115 thru 120 | Corp credit card payable (1 . . . N) |
| 21 | 121 thru 126 | Invoice income client customer (1 . . . N) |
| 22 | 127 thru 132 | Interest income |

The action tokens themselves are 6 characters long. The NULL token (take no action) is 6 dashes (- - - - - -). The first 3 characters of the ActionToken specifies the amount to be posted as follows:

| Value | Meaning |
|---|---|
| TAM | Total amount |
| TLG | Total less GST |
| GST | GST amount |
| FXA | Foreign exchange adjustment = TAM * ($SYNRATE − 1.0) |
| CET | Canadian equivalent = TAM * $SYNRATE |
| SAM | Settling Amount |
| FXS | Foreign exchange settlement = SAM − TAM |
| CEG | Canadian equivalent GST = GST * $SYNRATE |

$SYNRATE is determined by looking up the synthetic exchange rate for the given transaction date. The synthetic exchange rate table is populated with values published by the Bank of Canada.

The next character (position 4) specifies the date to use when posting the transaction:

| Value | Meaning |
|---|---|
| E | Expense trans date |
| B | Bank trans date |
| C | Canceled cheque date |
| S | Cheque-stub date |

The next character (position 5) specifies what to do with the amount as follows:

| Value | Meaning |
|---|---|
| D | Debit |
| C | Credit |

The last character (position 6) specifies what to do with the Entity value as follows:

| Value | Meaning |
|---|---|
| E | Use provided Entity value when posting |
| O | Use NULL Entity value when posting |

The following is an example of an ActionVerb that specifies:

1) The total amount of a transaction is to be credited to the shareholder's account along with the Entity value (if specified)

2) The total amount less GST is debited to the account associated with the classification (IE auto expense, office supplies, etc)

3) The GST amount is to be debited to the GST payable account

TAMECE---TLGEDO---GSTEDO--- . . . ---

In accordance with the above, the various ActionVerbs constitute commands for converting specific data identified using the ConditionKeys to the accounting software package. In particular, the ActionVerbs constitute commands for converting single entry data in the database 26 to double entry data that balances out in the accounting software package.

In a particular implementation of the present invention, this occurs when the export facility 42 is engaged to interact with the database 26 such that the export facility 42 blindly looks up the ConditionKeys obtained from a known inference engine that includes the database table referred to above. If the inference engine finds the corresponding ConditionKey then it executes the corresponding ActionVerb. If it does not find a corresponding ConditionKey then it generates an error since there is no ActionVerb for the particular piece of single entry data at hand.

Once the data is converted to double entry and loaded into the accounting software package (in this example CaseWare™) financial statements are generated. These financial statements permit the user to drill down to reviewing supporting documents. This in turn promotes transparency of financial statements, in that spot audits of financial statement entries can be readily verified by driving down to earmarked supporting documentation.

Another aspect of the present invention is that the business rules that are at the core of the export facility 42 disclosed are readily changed by modifying ConditionKeys and ActionVerbs in a manner that is known. One advantage of the export facility 42 of the present invention is that it is readily understood by accountants and thereby their feedback required for updating or modifying the operation of this facility is more readily obtained.

It should be understood that ConditionKeys could also be obtained by application of an artificial intelligence computer product or method.

It should be understood that one of the aspects of the present invention is that the data entry function can be delegated to the Data Entry Personnel 14 whereby data is entered over the Internet in a disparate geographic location, for example, one where labour costs are lower. The quality control function, on the other hand, is delegated to Accounting Personnel 16 in the jurisdiction of the Clients 18 such that they can verify that reconciled books created in accordance with the present invention meet the accounting rules of that particular jurisdiction.

Another aspect of the present invention is that the database 24 and the known database management facility 26 are provided in a manner that, for example, Clients 18 can only access their own data. In cooperation with Administration Facility, for example, in an implementation of the present invention with an accounting firm, accountants associated with a particular office can only view Client 18 data wherein the clients are clients of that office.

Other variations and modifications of the invention are possible. For example, as stated above, the present invention can be readily modified to extract reconciled books from a variety of commonly used documents in a number of industries such as Real Estate Contracts, Waybills, Purchase Orders, Shipping Documents, Inventory Reports, General Contracts and so on. For each new type of document data entry screens would be added to support the data capture and the reconciling facility 32 would be extended to apply the appropriate tests. It would also be obvious to modify the present invention to permit exporting to a number of other accounting packages such as Quickbooks, MYOB, Simply Accounting, and so on. Various other features can be associated with the web publication tool 34 that in turn enhance the features of the various web pages described herein. Additional features can be added to the system contemplated herein, without departing from the spirit of this invention. All such modifications or variations are believed to be within the sphere and scope of the invention as defined by the claims appended hereto.

We claim:

1) A method of providing web-enabled accounting comprising the steps of:
a) Providing a plurality of financial documents for loading to a database functionally linked to a web server;
b) Providing a reconciling facility that reconciles financial documents in accordance with a plurality of predetermined business rules; and
c) Applying the reconciling facility to the plurality of financial documents to produce a reconciled set of books.

2) The method claimed in claim 1, comprising the further steps of:
a) Providing a linking facility that links the plurality of financial documents; and
b) Applying the linking facility to the financial documents such that access to financial documents that either support an entry in the reconciled set of books, or another financial document, is enabled from the web server by means of a remote browser by clicking a corresponding link in the browser.

3) The method of claim 2, comprising the further steps of:
a) indexing the data comprising the reconciled set of books for supporting export to an accounting computer program;
b) exporting the data comprising the reconciled set of books to an accounting computer program; and
c) producing double entry account statements using the accounting computer program.

4) The method of claim 1, comprising the further steps of:
a) identifying gaps between the financial documents and the data required to produce a reconciled set of books using the reconciling facility; and
b) producing an error list identifying the information required to fill such gaps.

5) The method of claim 4, comprising the further step of designating the error list for rectification in accordance with a rectification protocol.

6) The method of claim 5, whereby the rectification of the error list involves designated personnel.

7) The method of claim 1, comprising the further step of electronically entering data to the web server that is required to produce a reconciled set of books and is otherwise not available electronically, using one or more data entry interfaces.

8) The method of claim 7, comprising the further step of ensuring the integrity and accuracy of financial documents provided to the web server in accordance with one or more data input interfaces, wherein the data input interfaces include quality control routines.

9) The method of claim 3, comprising the further step of providing access to a user to his/her reconciled set of books and underlying financial documents electronically by accessing the web server using a browser upon providing predetermined identification data.

10) A method of obtaining web-enabled accounting comprising the steps of:
a) Subscribing to a web-enabled accounting service;
b) Providing financial documents to a remote web server for processing the financial documents to produce a reconciled set of books in electronic form;
c) Responding to an error list where data is required to complete the web-enabled accounting process;
d) Accessing the reconciled set of books, and supporting financial documents, by accessing a web page provided by the web server via a browser by clicking one or more corresponding links.

11) A system for providing web-enabled accounting comprising:
a) A web server connected to the Internet;
b) A database functionally linked to the web server; and
c) A server application loaded on the web server, whereby the web server, database and server application are functionally linked to provide:
i) A data input facility for receiving a plurality of financial documents and storing said plurality of financial documents to the database in an electronic form; and
ii) a reconciling facility that reconciles financial documents in accordance with a plurality of business rules for reconciling financial documents;
wherein the reconciling facility reconciles the plurality of financial documents to produce a reconciled set of books in an electronic form.

12) The system claimed in claim 11, further comprising a linking facility that links the plurality of financial documents such that financial documents that either support an entry in the reconciled set of books, or another financial document, can be accessed from the database via web server and viewed in a remote browser by clicking a corresponding link.

13) The system claimed in claim 11, wherein the reconciling facility is further adapted to:
a) identify gaps between the financial documents and the data required to produce a reconciled set of books using the reconciling facility; and
b) produce an error list identifying the information required to fill such gaps.

14) The system claimed in claim 13, wherein the reconciling facility escalates the error list in accordance with a rectification protocol.

15) The system claimed in claim 14, wherein the system further comprises a communication facility, and wherein the reconciling facility and the communication facility cooperate to communicate the error list to designated personnel for rectification.

16) The system claimed in claim 15, wherein the database is a relational database and the system further includes a database management facility, wherein the relational database supports queries from the database management facility across the database.

17) The system as claimed in claim 16, wherein the system further includes an administration facility for controlling access to the resources of the web server.

18) The system as claimed in claim 16, wherein the system further includes a data export facility which is adapted to:
a) index the data comprising the reconciled set of books for supporting export to an accounting computer program; and
b) export the data comprising the reconciled set of books to an accounting computer program such that generation of a double entry account statement based on such data is enabled.

19) The system as claimed in claim 18, wherein the data input facility further includes one or more data input interfaces for managing the workflow of data entry of the financial data to the database in accordance with a quality control process.

20) A server computer product for loading on a web server, said server computer product comprising:
a) A data input facility for receiving a plurality of financial documents and storing said plurality of financial documents to the database in an electronic form; and
b) a reconciling facility that reconciles financial documents in accordance with a plurality of business rules for reconciling financial documents;
wherein the reconciling facility reconciles the plurality of financial documents to produce a reconciled set of books in an electronic form.
